(19) United States
(12) Patent Application Publication
(10) Pub. No.: US 2005/0097842 A1
(43) Pub. Date: May 12, 2005

(54) Water resistance sliding door system

(76) Inventors: Edmond Arcamonte, Miami, FL (US); Angel Mestres, Miami, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 10/734,341

(22) Filed: Dec. 11, 2003

Related U.S. Application Data
(60) Provisional application No. 60/518,455, filed on Nov. 7, 2003.

(51) Int. Cl. E06B 3/00

(52) U.S. Cl. 52/204.5

(57) ABSTRACT

A sliding door system having several air sealing structures and mechanisms for use under severe storm condition is disclosed. The sliding door system includes a top and a bottom sealing blocks attached to the top and bottom portions of the door frame, which have block sealing rims on the external walls, and a pair of sealing brackets along the top and bottom portions of the sliding door panel sashes. When the sliding door panel is in a closed condition, the block sealing rims are in direct contact with the sealing brackets to prevent water entrance under a strong wind. The bottom and top portions of the door system along the fixed door panel also have sealing structures to provide air sealing. Moreover, the sliding door system has an interior screen panel, which is protected from the wind at the exterior of the housing.

### CROSS REFERENCE TO RELATED APPLICATIONS

This application is a non-provisional patent application of the provisional patent application Ser. No. 60/518,455, filed on Nov. 7, 2003, which is herein incorporated by reference in its entirety.

### FIELD OF THE INVENTION

The present invention relates to a sliding door system, more specifically to a sliding door system which has multiple sealing means for preventing entrance of wind and water under severe storm condition, and structures preventing the sliding glass door panel and screen panel from being blown out by wind.

### BACKGROUND OF THE INVENTION

Various window and glass doors have been developed in an effort to avoid entrance of water and structural damage that may result from high winds, as may be experienced in a hurricane. For example, as a result of the widespread destruction caused by hurricane Andrew in 1992, new standards have been proposed in certain southern Florida counties to provide stronger windows and doors to decrease the damage to building structures during severe storms. The glass used in wind resistant windows and doors is typically a laminated glass panel and includes at least one plastic reinforcing layer and one or more glass layers.

In addition to the materials, the structures of the sliding glass door assembly is very important for preventing entrance of wind and water through the sliding doors into the building, and maintaining the integrity of the sliding door. Commonly, during a severe storm high winds carrying rain push into the building through the spaces at interfaces between door panels with the door frame, particularly between the sliding door panel and the door frame, especially at the bottom. The wind forced at the spaces of the interfaces can also lift the sliding door panel, either causing distortion of the door frame structure or having the sliding door panel blown out of the door frame.

Another challenge to the sliding glass door assembly is on the sliding screen panel. Traditionally, the sliding screen panel is positioned at the most exterior of a sliding door assembly. During a severe storm, the sliding screen panel sash tends to be deformed by strong winds. The whole screen panel is frequently blown away during a hurricane or tropical storm.

In addition to the structural integrity under storm condition, the exterior screen panel design also has other disadvantages. It is commonly recognized that the exterior screen panel collects dust whether in use or not, and becomes dirty easily. Furthermore, in a high rise building the exterior screen panel also affects the appearance of the glass doors, and the appearance of the whole building.

Therefore, it is desirable to have a sliding glass door system which has a sliding screen panel in the interior of the door assembly. It is also desirable to have an improved sliding door system which is resistant to storm weather condition.

### SUMMARY OF THE INVENTION

In one embodiment, the present invention provides a sliding glass door system which comprises (a) a door frame to be positioned in a structure opening, the door frame comprising a sliding door panel roller track extending along a bottom portion, a sliding door panel sliding track extending along a top portion, the sliding door panel roller and sliding tracks being positioned at an exterior side of the door frame; (b) at least one fixed door panel, the fixed door panel comprising a fixed door sash, and a glass panel carried in the fixed door sash, the fixed door panel being positioned at an interior side of the door frame; (c) at least one sliding door panel slidably positioned between the sliding door panel roller and sliding tracks, the sliding door panel comprising a sliding door sash and a glass panel carried in the sliding door sash, sliding door rollers extending outwardly from a bottom of the sliding door sash and engaging the sliding door panel roller track; and wherein the sliding door panel has a pair of sliding door sealing brackets on an internal side of the sliding door sash, extending horizontally along a top and a bottom portion of the sliding door sash; and (d) a bottom sealing block and a top sealing block horizontally aligned between the fixed door panel and an opposing side portion of the door frame for a two panel door system, or between two the fixed door panels for a three or four panel door system, and adjacent to the sliding door panel tracks; wherein each of the sealing blocks has a resilient block external sealing rim attached to an external wall of the sealing blocks, extending horizontally along the sealing blocks; and wherein when the sliding door panel is in a closed position, the sliding door sealing brackets are in direct contacts with the block external sealing rims along the top and bottom sealing blocks to provide air sealing between the sliding door sash and the sealing blocks.

The bottom portion of the door frame has a base section and a side section, which has a first and a second bottom frame anchoring means. The bottom sealing block has a first and a second bottom block anchor means complementary to the first and second bottom frame anchor means, respectively. The bottom sealing block is snapped on to the bottom portion of the door frame, by interlocking the first and second bottom block anchor means with the first and second bottom frame anchor means, respectively.

Furthermore, there are sealing means between the bottom sealing block and the side section of the bottom portion of the door frame. The sealing means can either attached to the internal wall of the bottom sealing block, or attached to the inner side of the side section of the bottom portion of the door frame. In either structure, the sealing means provide additional sealing of the sliding door system.

The fixed door panel further comprises a fixed door panel anchoring means complementary to said first bottom frame anchor means for interlocking said fixed door panel with said bottom portion of said door frame. Moreover, the fixed door panel further comprises a bottom fixed door sealing bracket on an internal side of said fixed door sash, extending horizontally along a bottom portion of said fixed door sash; and wherein said bottom fixed door sealing bracket is in direct contact with said bottom frame sealing rim of said bottom portion of said door frame to provide an additional sealing of said door system.

The top portion of said door frame has a top base section connected perpendicularly to an interior section, a middle section and an exterior section. The top portion has a first and a second top frame anchor means thereon. The top sealing block has a first and a second top block anchor means complementary to said first and second top frame anchor means, respectively. Similarly, the top sealing block is snapped on to said top portion of said door frame, by interlocking said first and second top block anchor means with said first and second top frame anchor means, respectively.

Furthermore, there are sealing means between the top sealing block and the internal section of the top portion of the door frame. The sealing means can either attached to the internal wall of the top sealing block, or attached to the inner side of the internal section of the top portion of the door frame. With either structure, the sealing means provide a sealing at the top portion of the sliding door system.

In one embodiment, the fixed door panel further comprises a first top fixed door sealing bracket on an internal side of the fixed door sash, extending horizontally along a top portion of the fixed door sash, and a first top fixed door sealing rim attached to the top fixed door sealing bracket; wherein the top fixed door sealing rim is in direct contact with the internal section of the top portion of the door frame to provide an additional sealing of the door system.

Moreover, the fixed door panel further comprises a second top fixed door sealing bracket on an external side of the fixed door sash, extending horizontally along a top portion of the fixed door sash, and a second top fixed door sealing rim attached to the second top fixed door sealing bracket; wherein the second top fixed door sealing rim is in direct contact with the middle section of the top portion of the door frame to provide an additional sealing of the door system.

In an alternative embodiment, the top sealing rims can be attached to the inner side of the internal section and on the side of the middle section which interfaces with the fixed door panel.

Moreover, the sliding glass door system further comprises a pair of side sealing plates, each being attached to a lower end of a peripheral side of the each side portion of the door frame.

Additionally, the sliding glass door system further comprises one sill track block for each sliding door panel. The sill track block is attached to the bottom portion of the door frame external of the sliding door panel roller track, and positioned along a vertical fixed door sash which towards a center of the door frame; wherein the sill track block prevents the sliding door panel from being blown out from the door frame by a strong wind.

In a further embodiment, the present invention provides a sliding door system which comprises an interior sliding screen panel. In this sliding door system, the door frame has a pair of sliding screen panel tracks at the most interior of door frame, extending along the top and bottom portions of the door frame.

### BRIEF DESCRIPTION OF THE DRAWINGS

FIG. 1A is a schematic exterior view of one embodiment of the present invention.

FIG. 1B is a perspective interior view of one embodiment of the present invention.

FIG. 2 is an exploded view of the door frame of one embodiment of the present invention.

FIG. 3A is a perspective view of the fixed door panel and sliding door panel of one embodiment of the present invention.

FIG. 3B is a perspective view of the sliding screen panel of one embodiment of the present invention.

FIG. 4 is a cut-off top view of the sliding door system of one embodiment of the present invention showing the positions of the fixed door panel and sliding door panel in the sliding door system and the interior sliding screen panel track.

FIG. 5A is an exploded partial side view of the bottom sealing block and the bottom portion of the door frame of one embodiment of the present invention.

FIG. 5B is a partial side view of the bottom portion of the door frame of FIG. 8A, showing the connection between the bottom sealing block with the bottom portion of the door frame.

FIG. 5C is a partial side view of the bottom portion of the door frame of FIG. 2, with the sliding door panel installed.

FIG. 6 is a partial exterior view of the sliding door system of one embodiment of the present invention, showing the bottom sealing block and the sill track block installed on the bottom portion of the door frame.

FIG. 7A is an exploded partial side view of a bottom portion of the fixed door panel and the bottom portion of the door frame shown in FIG. 5A.

FIG. 7B is a partial side view of the bottom portion of the door frame of FIG. 7A, showing the connection between the fixed door panel with the bottom portion of the door frame.

FIG. 8A is an exploded partial side view of the top sealing block and the top portion of the door frame of one embodiment of the present invention.

FIG. 8B is a partial side view of the top portion of the door frame of FIG. 8A, showing the connection between the top sealing block with the top portion of the door frame.

FIG. 8C is a partial side view of the top portion of the door frame shown in FIG. 2, showing the sealing between the top portion of the sliding door panel and the top sealing block, and the structure and position of the top sliding screen panel track.

FIG. 9A is an exploded partial side view of the top portion of the fixed door panel and the top portion of the door frame of the embodiment shown in FIG. 8A.

FIG. 9B is a partial side view of the top portion of the door frame of FIG. 9A, showing the connection between the top portion of the fixed door panel with the top portion of the door frame.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

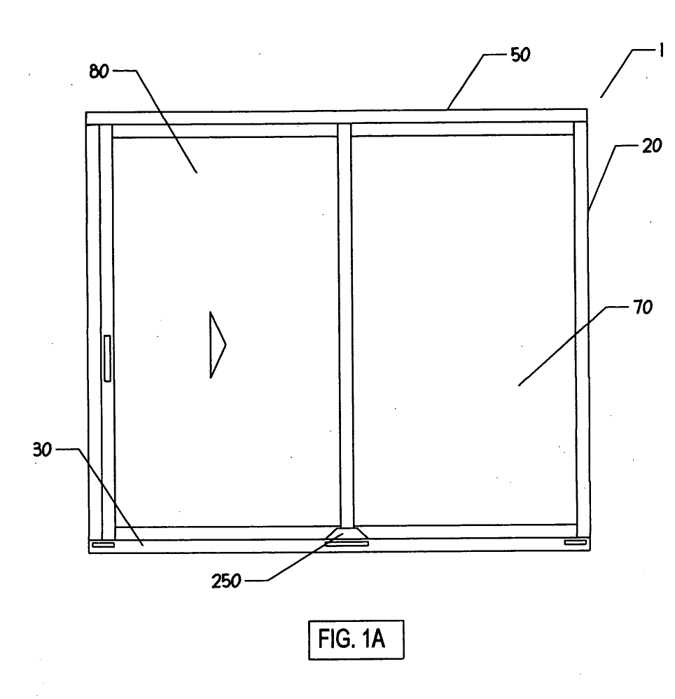

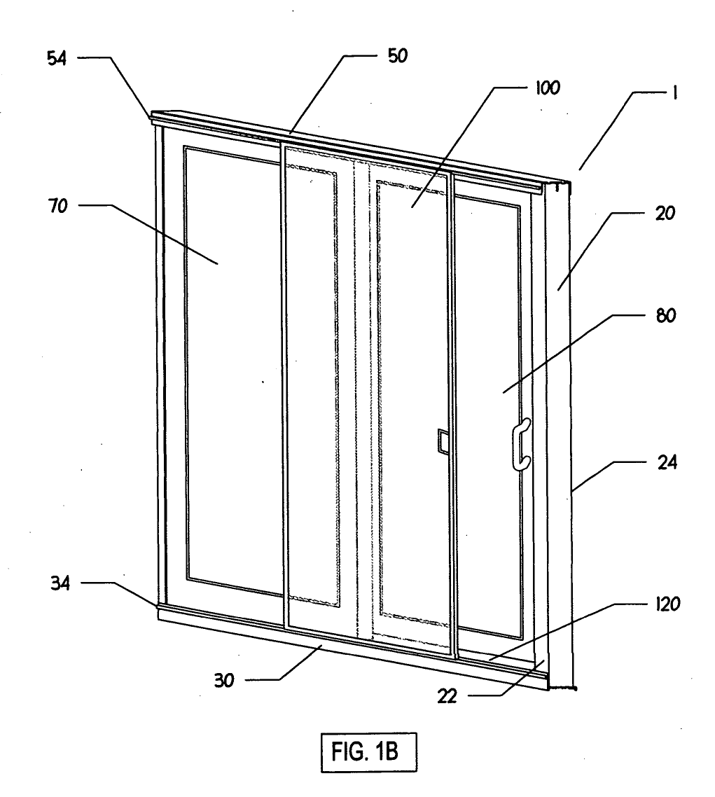

In one embodiment, the present invention provides a sliding glass door system 1, FIG. 1A shows a schematic external view of the sliding glass door system 1 of one embodiment of the present invention. The sliding glass door system comprises a door frame 20, one or more fixed door panel 70 positioned at the interior side of the door frame 20, a sliding door panel 80 positioned at the exterior side of the door frame 20, and a sliding screen panel 100 positioned at the most interior of the door frame 20. FIG. 1B shows an interior view of the sliding glass door system 1, with the sliding screen panel 100 at a partial opening position.

The sliding glass door system of the present invention can be two, three or four panel door systems. In a two panel door system, there is one fixed door panel 70 and one sliding door panel 80. In a three panel door system, there are two fixed door panels 70, one on each side of the door, and one sliding door panel 80 between the fixed door panels. In a four panel door system, there are two fixed door panels 70, one on each side of the door, and two sliding door panels 80 between the fixed door panels. Regardless numbers of panels, the positions of the fixed door panel, sliding door panel and the sliding screen panel in relation to the interior and exterior of the door frame are the same.

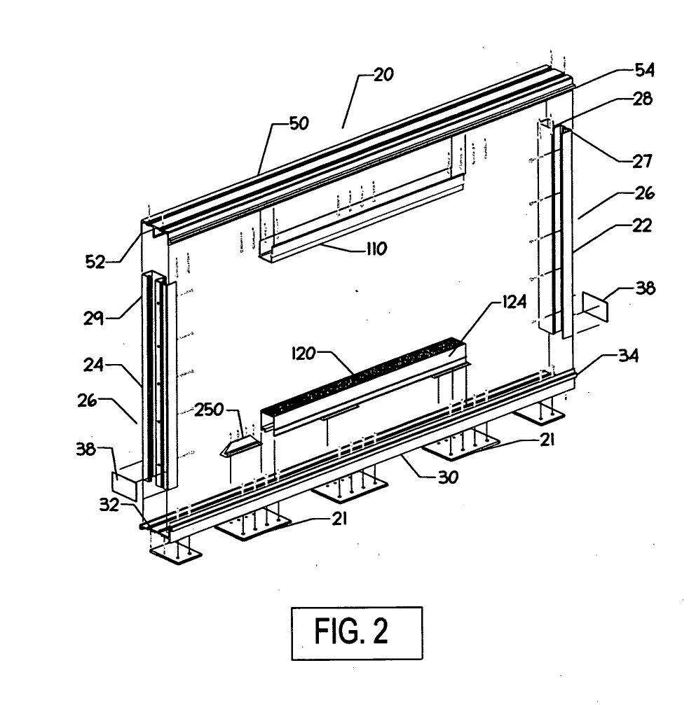

FIG. 2 shows a door frame of a four panel door system. The door frame 20 includes a sliding door panel roller track 32 extending along the bottom portion 30, a sliding door panel sliding track 52 extending along a top portion 50, and a pair of sliding screen panel tracks 34 and 54 extending along the bottom portion 30 and the top portion 50, respectively. The sliding door panel roller track 32 and sliding track 52 are positioned at an exterior side 24 of the door frame 20, and sliding screen panel tracks 34 and 54 are positioned at the most interior of the door frame 20.

The door frame 20 is mounted to the structure opening of the wall by mounting screws. As shown in FIG. 2, the bottom portion 30 is mounted to the floor through multiple mounting panels 21. The mounting screws are positioned along the bottom portion 30 near the interior side of the door frame 20. Upon installation, the bottom of the fixed door panel 70 is positioned on top of the mounting screws on one side of the door frame (or both sides for a three or four panel door), blocking the mounting screws from being seen by the users. Each of the side portions 26 has an indent portion 27 and a protruding portion 28. The protruding portion 28 is at the exterior side 24 and has a flat surface which is in contact with the side of sliding door panel 80 when it is in a closed position. The indent portion 27 is at the interior side 22 and has a flat base 29 directly in contact with the wall when mounted. The flat base 29 has plurality of mounting holes spaced along the vertical axis of the side portion 27. The side portions 26 are mounted to the structure opening by the mounting screws through the plurality of mounting holes, as shown in FIG. 2. Upon installation, one side of the fixed door panel 70 is inserted into the indent portion 27, blocking the mounting screws from being seen by the users. On the protruding portion 28, no mounting screws are used.

Furthermore, the door frame 20 further includes a pair of side sealing panels 38 attached to the lower end of the peripheral side of the side portions 26, as shown in FIG. 2. It has been found that water tends to leak into the house through the interfaces between the side portions 26 and the structure opening of the wall during severe storm condition because of the wind pressure. The side sealing panels 38 provide sealings at the interfaces, which prevents water entrance from the peripheral sides of the door system. The side sealing panel 38 has a height from about 4 to about 8 inches and a thickness from about 0.02 to about 0.06 inches. The width of the side sealing panel 38 substantially matches the width of the side portion 26 of the door frame. In one preferred embodiment, the side sealing panel 38 has a height of about 6 inches, a width of about 4.4 inches, and a thickness of about 0.04 inch. Preferably, the side sealing panels are sealed on to the peripheral side of the side portions 26 by a sealing material, such as silicone.

The top portion 50, bottom portion 30 and the side portions 26 are mounted together by mounting screws, as shown in FIG. 2. All the mounting screws are arranged at the locations which are not exposed to the users view. With this structural design, no mounting screws are in the view of users, which provides a clean and aesthetic appearance of the door frame.

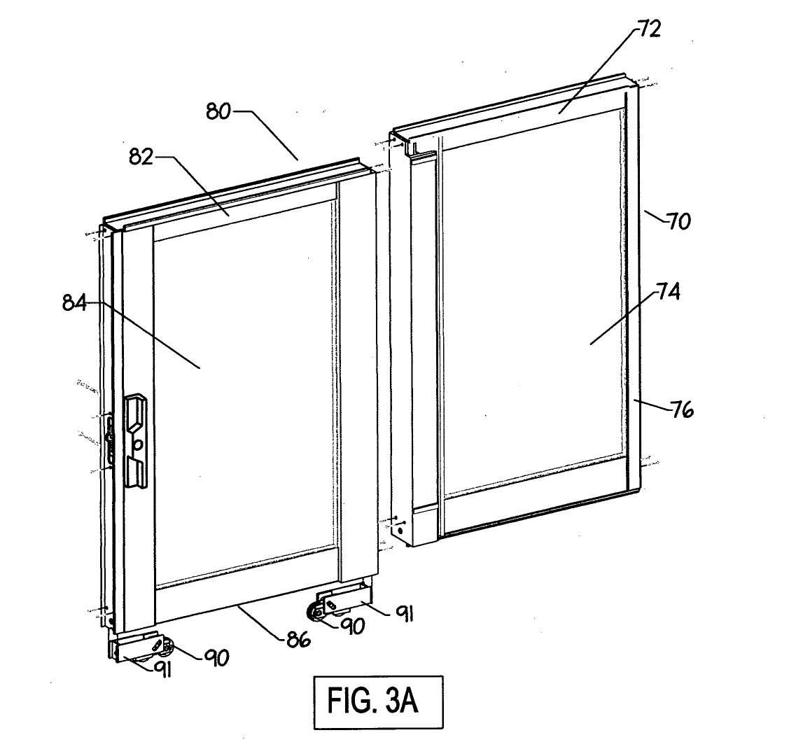

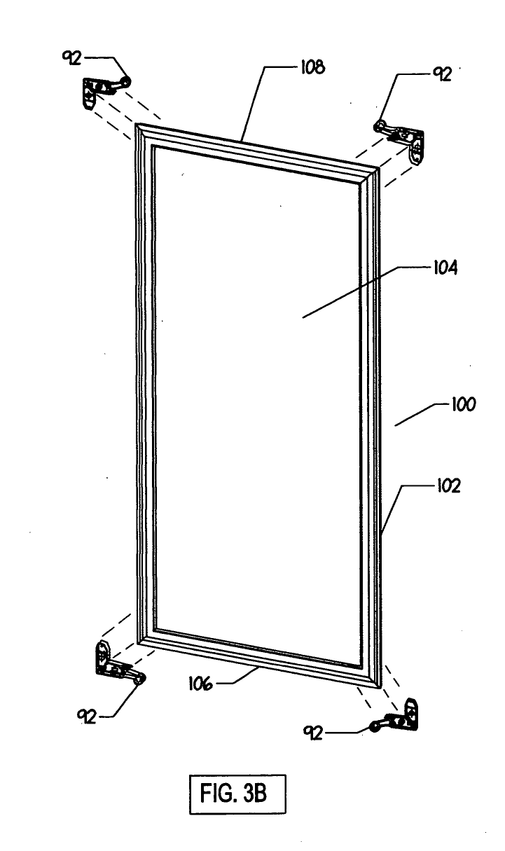

FIG. 3A shows the exterior view of the fixed door panel 70 and the sliding door panel 80. The fixed door panel 70 includes a fixed door sash 72, and a glass panel 74 carried in the fixed door sash 72. The fixed door panel 70 is positioned at the interior side 22 of the door frame 20, with its external side 76 adjacent to the roller track 32 and its internal side 78 facing the inside of the house. The fixed door frame 70 is connected to the door frame 20 by anchoring means at the bottom of the fixed door panel 70, as described in detail hereinafter. Furthermore, the fixed door panel 70 has a bottom sealing bracket 73 on the internal side 78 along the bottom portion of the fixed door sash 72; and an internal top sealing bracket 75 and an external top sealing bracket 77 along the top portion of the fixed door sash 72 for providing air sealing of the door system, which are described in detail hereinafter.

As shown in FIG. 3A, the sliding door panel 80 includes a sliding door sash 82 and a glass panel 84 carried in the sliding door sash 82, and rollers 90 which extends outwardly from a bottom 86 of the sliding door sash 82 and engages the roller track 32 at the bottom portion 30 of the door frame 20. In one embodiment, there are a total of four rollers 90 in two pairs. Each pair is mounted on a roller jacket 91. On the internal side 88 the sliding door panel 80 has a pair of sealing brackets 83 along the top and bottom portions of the sliding door sash 82 for providing air sealing of the door system, which are described in detail hereinafter.

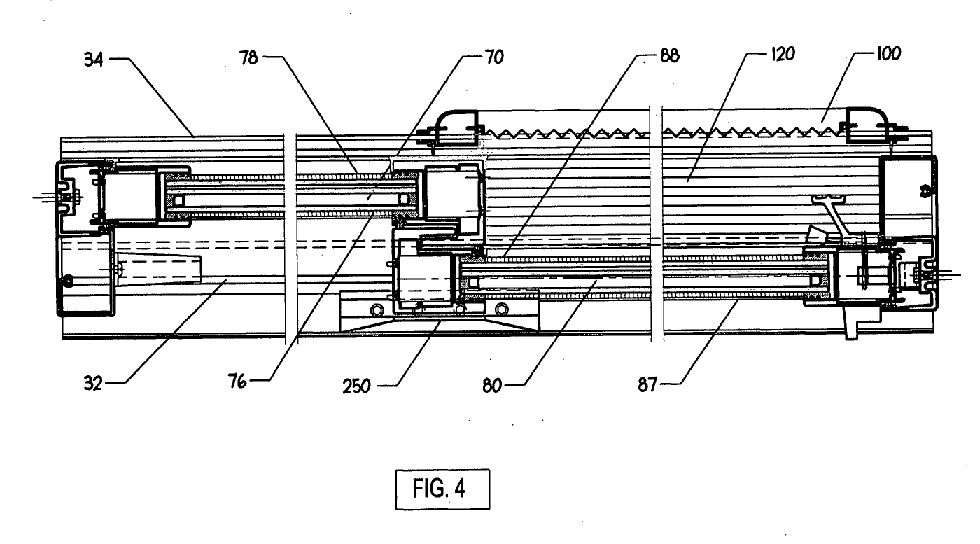

The sliding door panel 80 slidably positions between the sliding door panel roller track 32 and the sliding door panel sliding track 52 of the door frame 20. It slides along the tracks 32 and 52, at the external side 76 of the fixed door panel 70, as shown in FIG. 4.

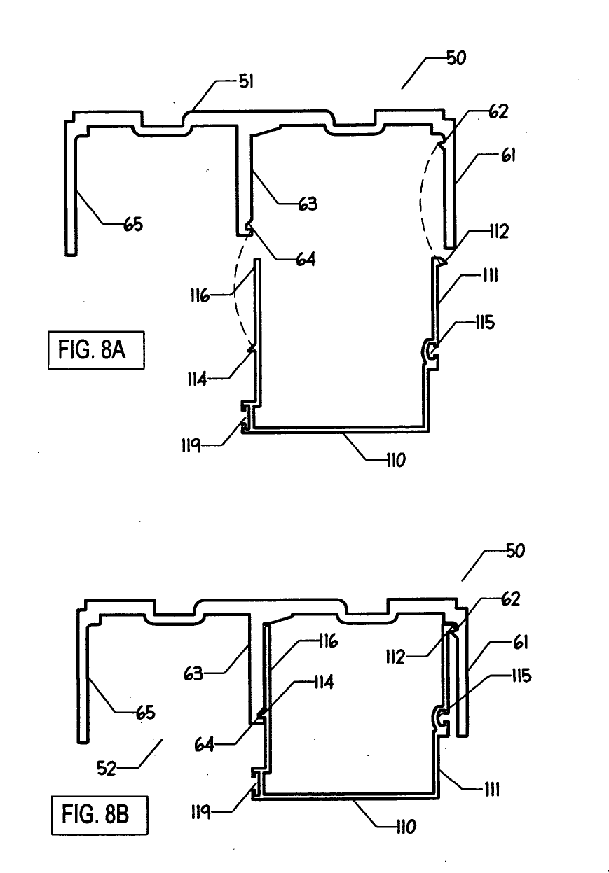

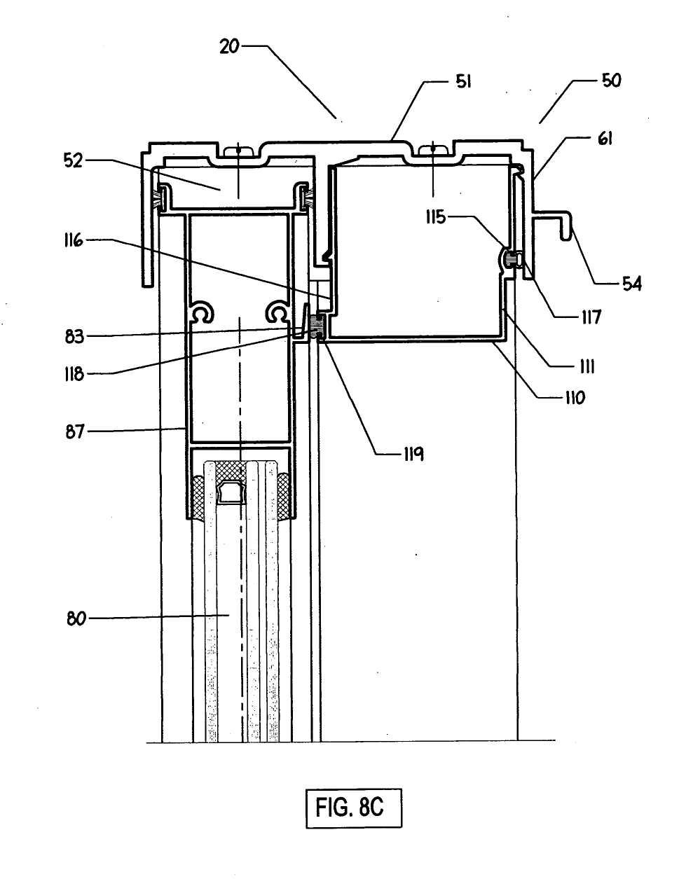

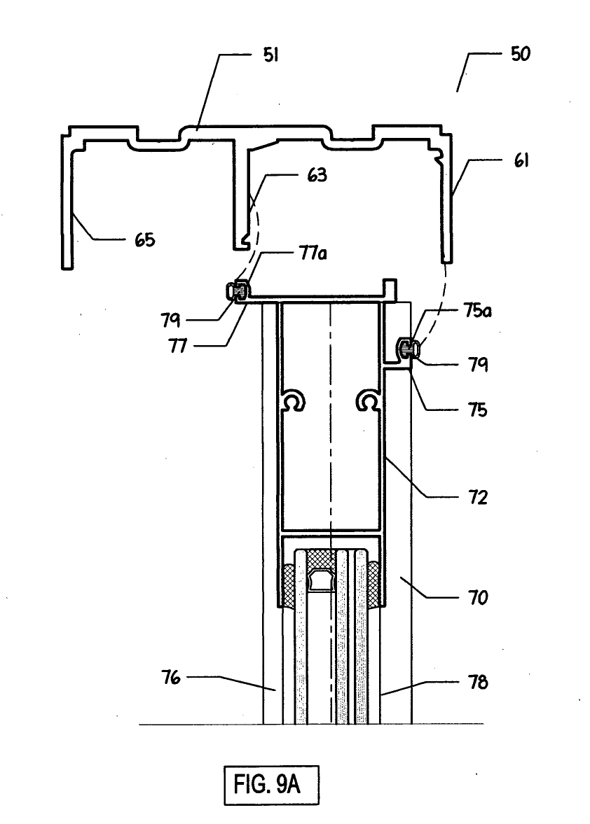

As shown in FIG. 3B, the sliding screen panel 100 includes a sliding screen sash 102 and a screen panel 104 carried in the sliding screen sash 102, and rollers 92 at a bottom 106 and a top 108 of the sliding screen sash 102, which engage the bottom sliding screen panel track 34 and the top sliding screen panel track 54. The sliding screen panel 100 slides along the sliding screen panel tracks 34 and 54, at the internal side 78 of the fixed door panel 70, as shown in FIG. 4. FIG. 8C shows the structure and the position of the top sliding screen panel track 54 of the door frame 20 in one embodiment of the present invention. The bottom sliding screen panel track 34 can have the same structure.

Different from the traditional sliding door system, the interior sliding screen panel of the present invention will be not be deformed or blown away by wind because it is positioned most interior of the door assembly. Furthermore, under a normal use condition, the interior screen panel does not collect dust when it is not in use. Moreover, with the interior screen panel the exterior of the sliding glass door has a complete glass look, which provides an aesthetic appearance for a high rise building.

As shown in FIG. 2, the door frame 20 further includes a bottom sealing block 120 and a top sealing block 110, which are adjacent to the sliding door panel tracks 32 and 52, respectively, for providing sealing between the sliding door sash 82 and the sealing blocks 110 and 120 to prevent entrance of wind and water under storm weather condition. For a two panel door system, the sealing blocks 110 and 120 are between the fixed door panel 70 and the opposing side of the door frame 20. For a three panel or four panel door systems, the sealing blocks are between two fixed door panels 70.

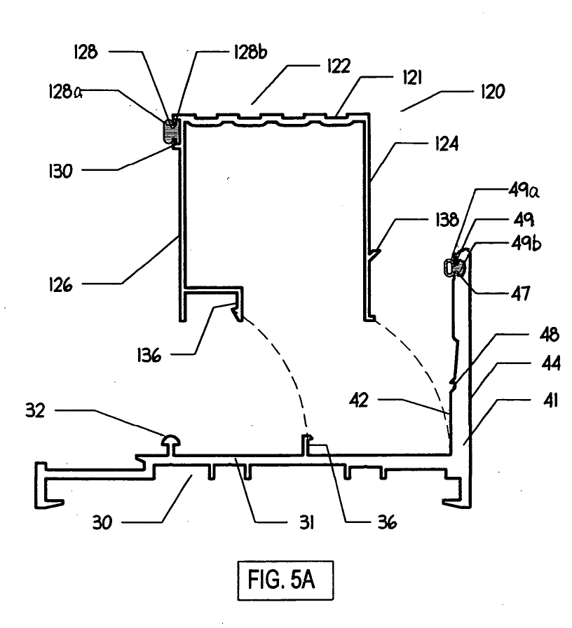

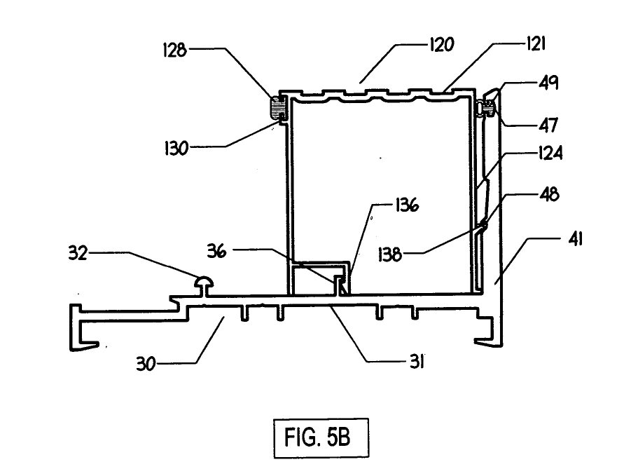

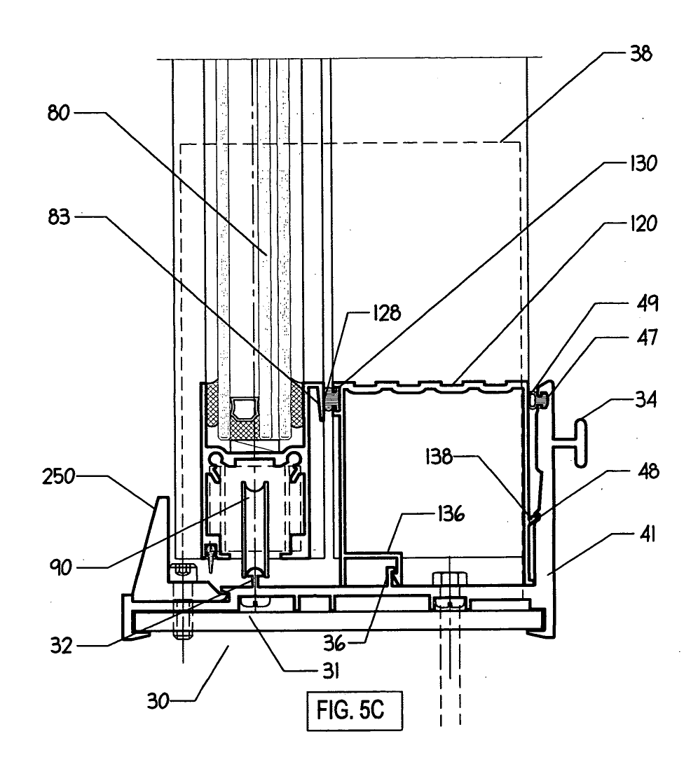

Now referring to FIGS. 5A and 5B, which show the detail structures of the bottom portion of the door frame and the bottom sealing block 120 of the door frame 20 shown in FIG. 2, without the bottom screen panel track 34. As shown, the bottom portion 30 of the door frame 20 has a bottom base section 31 connected perpendicularly to a bottom side section 41. The bottom portion 30 has a first and a second bottom frame anchor means 36 and 48 thereon. In one embodiment as shown in FIG. 5A, the first bottom frame anchor means 36 is a base anchor, and the second bottom frame anchor means 48 is a side anchor slot on the inner side 42 of the bottom side section 41.

Furthermore, near the top of the inner side 42, there is a bottom frame sealing rim slot 47. A resilient bottom frame sealing rim 49 is inserted into the rim slot 47. The resilient sealing rim can be made of rubber or other suitable materials. In one embodiment, the sealing rim 49 is made of a thin rubber sheet which is folded, with the edge portions mounted inside the rim slot 47. The folded portion of the rubber sheet protrudes from the bottom side section 41 and forms the resilient sealing rim 49. In a preferred embodiment as shown in FIGS. 5A and 5B, the resilient sealing rim 49 is a pre-manufactured gasket having an anchoring base 49b to be mounted inside the rim slot 47, and a resilient rim head 49a which protrudes from the inner side 42 of the bottom side section 41.

As shown, the bottom sealing block 120 has a rectangular shape with a top 122, an internal wall 124, and an external wall 126. The bottom sealing block 120 has a first and a second bottom block anchor means 136 and 138, which are complementary to the first and second bottom frame anchor means 36 and 48, respectively, of the door frame. In one embodiment shown in FIGS. 5A and 5B, the a first bottom block anchor means 136 is a foot anchor extending from the inside of the external wall 126, and the second bottom block anchor means 138 is a side anchor protruding from the internal wall 124.

Furthermore, near the top of the external wall 126, there is a bottom block sealing rim slot 130. A resilient block sealing rim 128 is inserted into the rim slot 130. In one embodiment, the sealing rim 128 is made of a thin rubber sheet which is folded, with the edge portions mounted inside the rim slot 130. The folded portion of the rubber sheet protrudes from the external wall 126 and forms the resilient sealing rim 128. In a preferred embodiment as shown in FIGS. 5A and 5B, the resilient sealing rim 128 is a pre-manufactured gasket having an anchoring base 128b to be mounted inside the rim slot 130, and a resilient rim head 128a which protrudes from the external wall 126. Because of frequent contacts with the sliding door panel 80, the resilient rim head 128a is in a solid form for durability.

At the installation, the bottom sealing block 120 is snapped on to the bottom portion 30 of the door frame. Once it is snapped on, the foot anchor 136 and side anchor 138 of the bottom sealing block 120 interlock with the base anchor 36 and the side anchor slot 48 of the bottom portion 30 of the door frame, thereby the bottom sealing block 120 is firmly attached to the door frame. It should be understood that various other anchoring structures and mechanisms can also be utilized for interlocking the bottom sealing block 120 with the bottom portion 30 of the door frame. Preferably, the bottom sealing block 120 has a height from about 2.5 to about 4.0 inches, which forms a physical block to the water entrance in case that the outside floor is flooded. Additionally, the bottom sealing block 120 has a plurality of grooves 121 on the top 120 to provide a non-slippery walking surface.

As shown in FIG. 5B, upon installation the internal wall 124 of the bottom sealing block 120 is in direct contact with the bottom frame sealing rim 49, which provides a sealing between the bottom sealing block 120 and the side section 41 of the door frame. Alternatively, such a sealing can also be provided with a reversed structure. More specifically, the sealing rim slot 47 and sealing rim 49 can be on the internal wall 124, which provides a sealing contact with the inner side of the bottom side section 41. Such a structural arrangement is shown hereinafter in FIG. 8C.

As shown in FIG. 5C, upon installation of the sliding door panel on the door frame, the bottom block sealing rim 128 is in direct contact with the sealing bracket 83 of the sliding door panel 80. As shown, the sealing bracket 83 protrudes from the bottom portion of the sliding door sash 82, wherein the planner surface is in contact with the protruding bottom block sealing rim 128 along the entire width of the sliding door panel 80 and the bottom sealing block 120. Therefore, when the sliding door panel 80 is in a closed position, the air sealing provided by the sealing bracket 83 and the sealing rim 128 prevents the entrance of wind and water from outside of the door system under severe storm conditions.

Additionally, in the embodiment shown in FIG. 5C, the bottom portion 30 of the door frame 20 has the bottom sliding screen panel track 34 extending from the outer side 44 (which faces the interior of the house) of the bottom side section 41. It is apparent that whether the bottom side section 41 includes the bottom sliding screen panel track 34 or not, the above-described interlocking mechanisms and sealing mechanisms between the door frame and the bottom sealing block 120 can be the same.

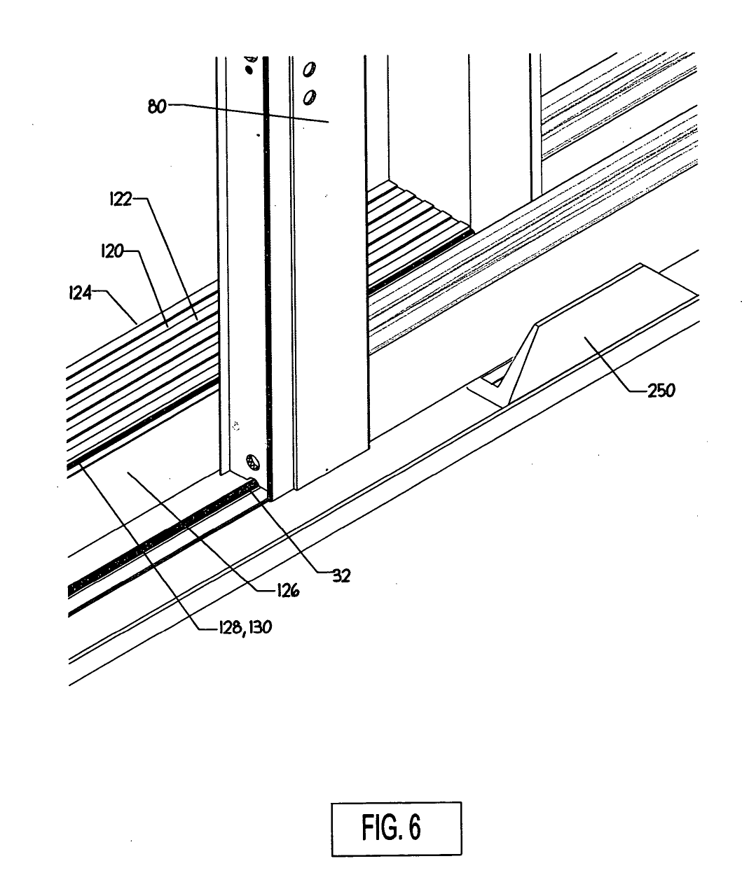

FIG. 6 further illustrates a perspective exterior view of the bottom sealing block 120 in an installed door system 1. Furthermore, the door frame 20 further comprises a sill track block 250 attached to the base portion 31, external of the sliding door panel roller track 32. The sill track block 250 is positioned along a vertical fixed door sash which towards the center of the door frame. When the sliding door panel 80 is in a closed position, one corner of the sliding door panel 80 is behind the sill track block 250. During a hurricane, when the direction of the wind is from inside of the sliding door, for example, when the windows on the opposite side of the house are broken, which is a very common situation during hurricanes, the pressure generated at the inside of the sliding door system can lift the sliding door panel 80 off the sliding door panel roller track 32 and blow the sliding door panel 80 out of the door frame 20. With the sill track block 250, the sliding door panel 80 can be locked inside the door frame 20 in the presence of such strong wind pressure. The door system 1 can have more than one sill track block 250. For is a four panel door system, there can be three sill track blocks 250, one for each meeting point of two door panels, i.e., at the meeting point of two sliding door panels, and at the two meeting points of two sliding door panels with two fixed door panels.

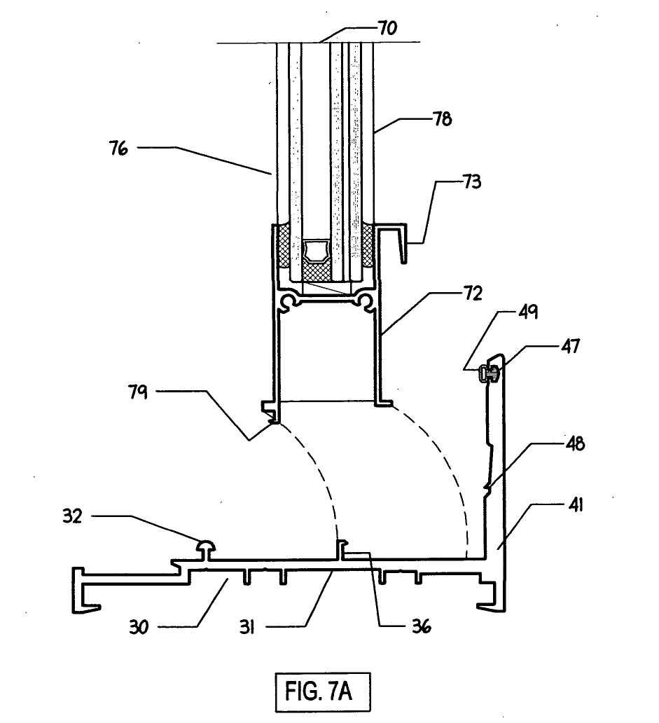

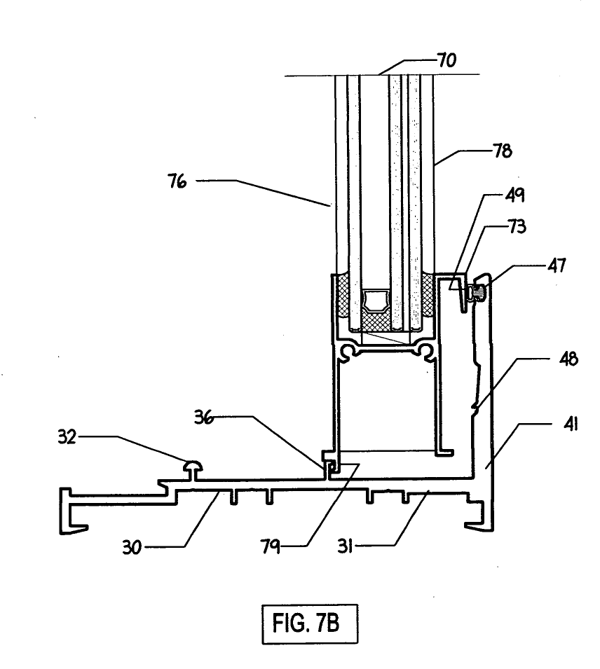

Now referring to FIGS. 7A and 7B, which show the detail structures of the bottom portion of the fixed door panel 70 and its connection with the door frame. As shown, the fixed door panel 70 has a bottom anchoring means 79 underneath the bottom portion of the fixed door sash 72, which is complementary to the base anchor 36 of the door frame. Upon installation, the bottom anchoring means 79 interlocks with the base anchor 36. Furthermore, the fixed door panel 70 has a bottom fixed door sealing bracket 73 protruding from the bottom portion of the fixed door sash 72 on the internal side 78. Preferably, the bottom fixed door sealing bracket 73 extends horizontally along the entire width of the fixed door panel. As shown, upon installation the planner surface of the bracket 73 is in direct contact with the bottom frame sealing rim 49, which provides a sealing between the fixed door panel and the bottom side section of the door frame. Again, such a sealing can be provided with a reverse structure, as described previously with the bottom sealing block.

FIGS. 8A to 8C illustrate the detail structures of the top sealing block 110 and the top portion of the door frame 20, with and without the top sliding screen panel track 54. As shown, the top portion 50 of the door frame has a top base section 51 connected perpendicularly to an interior section 61, a middle section 63 and an external section 65. The top portion 50 has a first top frame anchor means 62 and a second top frame anchor means 64 thereon. In the embodiment shown, the first top frame anchor means 62 is a side anchor on the internal section 62, and the second top frame anchor means 64 is a side anchor slot on the middle section 63.

The top sealing block 110 has a similar structure to the bottom sealing block 120, however with a substantially shorter height than the height of the bottom sealing block 120, since there is no requirement of blocking flooding water at the top of the door. As shown, the top sealing block 110 has a first top block anchor means 112 complementary to the first top frame anchor means 62, and a second top block anchor means 114 complementary to the second top frame anchor means 64, respectively. As shown, the anchor structures of the top sealing block 110 are different from those of the bottom sealing block 120, which demonstrates that different anchoring structures and mechanisms can be utilized for the interlocking the sealing blocks with the door frame.

Furthermore, the top sealing block 110 has two top sealing rim slots 115 and 119, one on the internal wall 111 and one on the external wall 116. A first resilient top block sealing rim 118, as shown in FIG. 8C, is inserted into the rim slot 119. Preferably, the top block sealing rim 118 has the material and structure of the bottom block sealing rim 128, therefore, the same part can be used for both top and bottom sealing blocks. A second resilient top block sealing rim 117, as shown in FIG. 8C, is inserted into the rim slot 115. The same structure and material used for the bottom frame sealing rim 49 can be used for the sealing rim 117.

Similar to the bottom sealing block 120, the top sealing block 110 is snapped on to the top portion of the door frame. Once it is snapped on as shown in FIG. 8B, the first anchor 112 and the second anchor 114 of the top sealing block 110 interlock with the side anchor 62 and the side anchor slot 64 of the top portion 50 of the door frame, thereby the bottom sealing block 110 is firmly attached to the door frame. It is noted that the middle section 63 and the external section 65 form the sliding door panel sliding track 52, which is more apparent in FIG. 8C.

FIG. 8C shows the top portion of the door frame with the sliding door panel 80 installed within. As shown, the first top block sealing rim 118 is in direct contact with the sealing bracket 83 of the sliding door panel 80, same as that described previously with the bottom sealing block 120. Therefore, when the sliding door panel 80 is in a closed position, the air sealing forms along both top and bottom portion of the sliding door panel.

On the other hand, the second top block sealing rim 117 is in direct contact with the internal section 61 of the door frame to provide an additional air sealing. Alternatively, such a sealing can also be provided by a reverse structure, as previously shown with the bottom frame sealing rim 49, which is attached to the door frame instead of the sealing block.

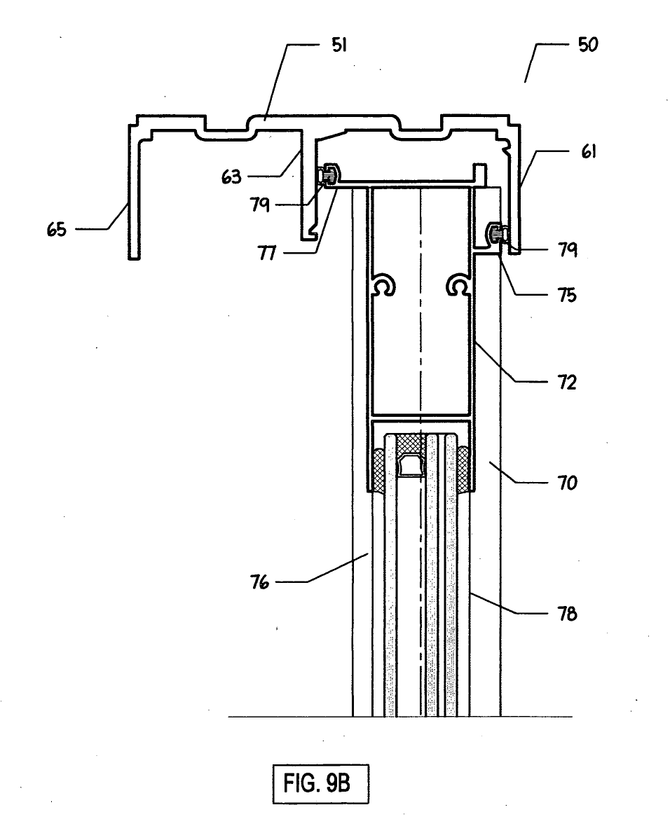

FIGS. 9A and 9B show the sealing mechanisms between the fixed door panel 70 and the top portion 50 of the door frame. As shown in FIG. 9A, the fixed door panel 70 has two top sealing brackets 75 and 77. Instead of the plane planner surface of the bottom sealing bracket 73, each of the top sealing brackets 75 and 77 has a sealing rim slot, as shown as 75a and 77a, respectively. A top sealing rim 79 is inserted into the sealing rim slots 75a and 77a. Preferably, the structure and the material of the sealing rim 79 is the same as the bottom frame sealing rim 49. Upon installation, as shown in FIG. 9B, the top sealing rims 79 of the top sealing brackets 75 and 77 are in direct contact with the internal section 61 and the middle section 63 of the top portion 50 of the door frame, which provide air sealing along the top portion of the fixed door panel 70. Alternatively, such a sealing can be provided by a reverse structure. More specifically, the top sealing rims 79 can be attached to the internal section 61 and the middle section 63 of the top portion 50 of the door frame, as previously described with the bottom side section 41 of the door frame.

The door frame 20, the fixed and sliding door sashes, and sliding screen panel sash can be made of metals, such as aluminum, steel, alloy, and other suitable materials, preferably, they are made of aluminum. The glass panel is preferably made of double or triple layers of glass, preferably, laminated glass.

While the present invention has been described in detail and pictorially shown in the accompanying drawings, these should not be construed as limitations on the scope of the present invention, but rather as an exemplification of preferred embodiments thereof. It will be apparent, however, that various modifications and changes can be made within the spirit and the scope of this invention as described in the above specification and defined in the appended claims and their legal equivalents.

1. A sliding glass door system comprising:
(a) a door frame to be positioned in a structure opening, said door frame comprising a sliding door panel roller track extending along a bottom portion, and a sliding door panel sliding track extending along a top portion, said sliding door panel roller and sliding tracks being positioned at an exterior side of said door frame;
(b) at least one fixed door panel, said fixed door panel comprising a fixed door sash, and a glass panel carried in said fixed door sash, said fixed door panel being positioned at an interior side of said door frame;
(c) at least one sliding door panel slidably positioned between said sliding door panel roller and sliding tracks, said sliding door panel comprising a sliding door sash and a glass panel carried in said sliding door sash, sliding door rollers extending outwardly from a bottom of said sliding door sash and engaging said sliding door panel roller track; and wherein said sliding door panel has a pair of sliding door sealing brackets on an internal side of said sliding door sash, extending horizontally along a top and a bottom portion of said sliding door sash; and.
(d) a bottom sealing block and a top sealing block horizontally aligned between said fixed door panel and an opposing side portion of said door frame for a two panel door system, or between two said fixed door panels for a three or four panel door system, and adjacent to said sliding door panel tracks; wherein each of said sealing blocks has a resilient block external sealing rim attached to an external wall of said sealing blocks, extending horizontally along said sealing blocks; and
wherein when said sliding door panel is in a closed position, said sliding door sealing brackets are in direct contacts with said block external sealing rims along said top and bottom sealing blocks to provide air sealing between said sliding door sash and said sealing blocks.

2. The sliding glass door system of claim 1, wherein said sliding door sealing brackets protrude from said sliding door sash.

3. The sliding glass door system of claim 1, wherein said bottom portion of said door frame comprises a bottom base section connected perpendicularly to a bottom side section; said bottom portion has a first and a second bottom frame anchor means thereon.

4. The sliding glass door system of claim 3, wherein said bottom sealing block has a first and a second bottom block anchor means complementary to said first and second bottom frame anchor means, respectively, for interlocking said bottom sealing block with said bottom portion of said door frame.

5. The sliding glass door system of claim 4, wherein said bottom sealing block is snapped on to said bottom portion of said door frame, by interlocking said first and second bottom block anchor means with said first and second bottom frame anchor means, respectively.

6. The sliding glass door system of claim 5, wherein there is a resilient bottom frame sealing rim attached to an inner side of said bottom side section of said door frame, extending horizontally along said bottom side section; and an internal wall of said bottom sealing block is in direct contact with said bottom frame sealing rim to provide an additional sealing of said door system.

7. The sliding glass door system of claim 5, wherein said fixed door panel further comprises a fixed door panel anchoring means complementary to said first bottom frame anchor means for interlocking said fixed door panel with said bottom portion of said door frame.

8. The sliding glass door system of claim 7, wherein said fixed door panel further comprises a bottom fixed door sealing bracket on an internal side of said fixed door sash, extending horizontally along a bottom portion of said fixed door sash; and wherein said bottom fixed door sealing bracket is in direct contact with said bottom frame sealing rim of said bottom portion of said door frame to provide an additional sealing of said door system.

9. The sliding glass door system of claim 8, wherein said bottom fixed door sealing bracket protrudes from said fixed door sash.

10. The sliding glass door system of claim 5, wherein said bottom sealing block further comprises a resilient bottom block internal sealing rim attached to an internal wall thereof, extending horizontally along said bottom sealing block; and said bottom block internal sealing rim is in direct contact with said bottom side section of said door frame to provide an additional sealing of said door system.

11. The sliding glass door system of claim 10, wherein said fixed door panel further comprises a bottom fixed door sealing bracket on an internal side of said fixed door sash, extending horizontally along a bottom portion of said fixed door sash, and has a bottom fixed door sealing rim attached to said sealing bracket; wherein said bottom fixed door sealing rim is in direct contact with said bottom side section of said bottom portion of said door frame to provide an additional sealing of said door system.

12. The sliding glass door system of claim 5, wherein said bottom sealing block covers mounting screws on said bottom portion of said door frame.

13. The sliding glass door system of claim 5, wherein said bottom sealing block further comprises a plurality of grooves on a top thereof to provide a non-slippery walking surface.

14. The sliding glass door system of claim 5, wherein said top portion of said door frame has a top base section connected perpendicularly to an interior section, a middle section and an exterior section; and said top portion has a first and a second top frame anchor means thereon.

15. The sliding glass door system of claim 14, wherein said top sealing block has a first and a second top block anchor means complementary to said first and second top frame anchor means, respectively, for interlocking said top sealing block with said top portion of said door frame.

16. The sliding glass door system of claim 15, wherein said top sealing block is snapped on to said top portion of said door frame, by interlocking said first and second top block anchor means with said first and second top frame anchor means, respectively.

17. The sliding glass door system of claim 16, wherein said top sealing block further comprises a resilient top block internal sealing rim attached to an internal wall thereof, extending horizontally along said top sealing block; and said top block internal sealing rim is in direct contact with an inner side of said interior section of said top portion to provide an additional sealing of said door system.

18. The sliding glass door system of claim 17, wherein said fixed door panel further comprises a first top fixed door sealing bracket on an internal side of said fixed door sash, extending horizontally along a top portion of said fixed door sash, and a first top fixed door sealing rim attached to said top fixed door sealing bracket; wherein said top fixed door sealing rim is in direct contact with said internal section of said top portion of said door frame to provide an additional sealing of said door system.

19. The sliding glass door system of claim 18, wherein said fixed door panel further comprises a second top fixed door sealing bracket on an external side of said fixed door sash, extending horizontally along a top portion of said fixed door sash, and a second top fixed door sealing rim attached to said second top fixed door sealing bracket; wherein said second top fixed door sealing rim is in direct contact with said middle section of said top portion of said door frame to provide an additional sealing of said door system.

20. The sliding glass door system of claim 16, wherein there is a resilient top frame sealing rim attached to an inner side of said interior section of said top portion, extending horizontally along said interior section; and an internal wall of said top sealing block is in direct contact with said top frame sealing rim to provide an additional sealing of said door system.

21. The sliding glass door system of claim 20, wherein said fixed door panel further comprises a top fixed door sealing bracket on an internal side of said fixed door sash, extending horizontally along a top portion of said fixed door sash; and wherein said top fixed door sealing bracket is in direct contact with said top frame sealing rim of said top portion of said door frame to provide an additional sealing of said door system.

22. The sliding glass door system of claim 16, wherein said top sealing block covers mounting screws on said top portion of said door frame.

23. The sliding glass door system of claim 16, wherein each of side portions of said door frame has an indent portion and a protruding portion, said indent portion being at said interior side and said protruding portion being at said exterior side of said door frame; and said each side portion is mounted to said structure opening by mounting screws vertically along said indent portion; and wherein upon installation, said fixed door panel is inserted into said indent portion of one side portion, thereby blocking mounting screws from an user's view.

24. The sliding glass door system of claim 23, wherein said door frame further comprises a pair of side sealing plates, each being attached to a lower end of a peripheral side of said each side portion of said door frame.

25. The sliding glass door system of claim 24, wherein said side sealing plates have a height from about 4 to about 8 inches.

26. The sliding glass door system of claim 16 further comprising one or more sill track block, said sill track block being attached to said bottom portion of said door frame external of said sliding door panel roller track, and positioned along a vertical fixed door sash which towards a center of said door frame; wherein said sill track block prevents said sliding door panel from being blown out from said door frame by a strong wind.

27. A sliding glass door system comprising:
(a) a door frame to be positioned in a structure opening, said door frame comprising a sliding door panel roller track extending along a bottom portion, a sliding door panel sliding track extending along a top portion, said sliding door panel roller and sliding tracks being positioned at an exterior side of said door frame; and
a pair of sliding screen panel tracks positioned at the most interior side of said door frame extending along said bottom and top portion;
(b) at least one fixed door panel, said fixed door panel comprising a fixed door sash, and a glass panel carried in said fixed door sash, said fixed door panel being positioned at an interior side of said door frame between said sliding door panel tracks and said sliding screen panel tracks;
(c) at least one sliding door panel slidably positioned between said sliding door panel roller and sliding tracks, said sliding door panel comprising a sliding door sash and a glass panel carried in said sliding door sash, sliding door rollers extending outwardly from a bottom of said sliding door sash and engaging said sliding door panel, roller track; and wherein said sliding door panel has a pair of sliding door sealing brackets on an internal side of said sliding door sash, extending horizontally along a top and a bottom portion of said sliding door sash; and.
(d) a sliding screen panel slidably positioned between said pair of sliding screen panel tracks in said door frame, said sliding screen panel comprising a sliding screen sash, a screen panel carried in said sliding screen sash and sliding screen rollers.

28. The sliding door system of claim 27 further comprising a bottom sealing block and a top sealing block horizontally aligned between said fixed door panel and an opposing side portion of said door frame for a two panel door system, or between two said fixed door panels for a three or four panel door system, and adjacent to said sliding door panel tracks; wherein each of said sealing blocks has a resilient block external sealing rim attached to an external wall of said sealing blocks, extending horizontally along said sealing blocks; and
wherein when said sliding door panel is in a closed position, said sliding door sealing brackets are in direct contacts with said block external sealing rims along said top and bottom sealing blocks to provide air sealing between said sliding door sash and said sealing blocks.
